(19) United States
(12) Patent Application Publication
(10) Pub. No.: US 2011/0049360 A1
(43) Pub. Date: Mar. 3, 2011

(54) Collision/Reaction Cell for a Mass Spectrometer

(76) Inventor: Alan E. Schoen, Saratoga, CA (US)

(21) Appl. No.: 12/553,907

(22) Filed: Sep. 3, 2009

(51) Int. Cl. H01J 49/26

(52) U.S. Cl. 250/290; 250/281

(57) ABSTRACT

A collision/reaction cell for a mass spectrometer includes an RF multipole having electrodes that are shaped and positioned such that the value of the radial spacing r₀ increases from the inlet to the outlet end. The longitudinally increasing r₀ improves transmission of relatively low-m/z product ions relative to a conventional collision/reaction cell design.

### FIELD OF THE INVENTION

The present invention relates generally to structures for controllably fragmenting ions in a mass spectrometer, and more particularly to collision/reaction cells utilizing radio frequency multipole structures.

### BACKGROUND OF THE INVENTION

Radio frequency (RF) multipoles are commonly used in mass spectrometers and similar instruments to efficiently transportions within vacuum regions. Typically, an RF multipole consists of a set of parallel elongated electrodes arranged around a central longitudinal axis. RF voltages are applied to the electrodes in a prescribed phase relationship to generate an oscillatory field that radially confines ions within the multipole interior volume while the ions traverse the RF multipole from an inlet end to an outlet end.

Certain mass spectrometers utilize collision cells, in which an RF multipole is placed within an enclosure pressurized with a collision gas, such as nitrogen or argon. Precursor ions that enter the collision cell collide with molecules or atoms of collision gas and undergo dissociation to yield product ions. The degree and pattern of fragmentation may be controlled by adjusting the kinetic energy at which the precursor ions enter the collision cell as well as the collision gas pressure. The resultant product ions are transported along the central axis of the multipole to the outlet end thereof, and are thereafter passed to downstream regions of the mass spectrometer for further processing and/or mass analysis.

It is known that product ions having low mass-to-charge ratios (m/z's) may tend to develop unstable trajectories in collision cells, causing them to be lost via contact with electrode surfaces or ejection from the multipole interior volume. Loss of low-m/z ions in the collision cell is undesirable, since they may carry information useful for identification or structural elucidation of analyte molecules. The stability of an ion in an RF quadrupole (the most commonly employed multipole in collision cells) is governed by the value of the Mathieu stability parameter q, which is proportional to the amplitude of the applied RF voltage and inversely proportional to the m/z of the ion. Typically, the RF voltage amplitude is selected such that the q of the precursor ions entering the quadrupole is about 0.2. Under these conditions, product ions having m/z's of less than 0.22 times the precursor m/z will have q's greater than 0.908 (the stability limit for an RF-only quadrupole) and will develop unstable trajectories. For example, if the RF voltage amplitude is tuned to set q=0.2 for a precursor m/z of 500, product ions having m/z's of less than 110 will be lost in the quadrupole and will not be available for detection in the downstream mass analyzer. The value of m/z below which ions are unstable (referred to in the art as the low mass cut-off, or LMCO) may be reduced by decreasing the RF voltage amplitude, but doing so will tend to reduce the transmission efficiency of heavier ions.

Another problem associated with prior art multipoles is that a small manufacturing error, such as a slight bowing or angular misalignment of an electrode, may produce trapping regions within the multipole interior volume that retain ions or impede their axial movement. This unintended trapping phenomenon, which may also arise from the accumulation of contaminants on electrode surfaces during operation of the mass spectrometer, reduces the rate at which ions may be removed from the multipole interior, which is particularly problematic for tandem mass spectrometry applications where it is highly desirable to remove ions from the collision cell quickly so that a large number of experiments (for example, multiple MRM transitions) may be performed across an elution peak. The rate at which ions are drawn through a multipole may be increased by superimposing an axial DC field (sometimes referred to as a “drag field”), which is described in U.S. Pat. Nos. 5,847,386 by Thomson et al. and 7,067,802 by Kovtoun. However, incorporating the additional structures and electronics required for producing the DC axial field may significantly increase manufacturing cost and complexity.

### SUMMARY

Roughly described, a multipole constructed in accordance with an embodiment of the present invention includes at least four elongated electrodes arranged around a longitudinal axis, and an RF voltage source for applying RF voltages to the electrodes in a prescribed phase relationship. The electrodes are formed and positioned such that the value of the radial spacing r₀ (the distance from the axis to the inner surface of each of the electrodes) increases from the inlet end to the outlet end of the multipole. In one implementation, the electrodes have uniform cross-sections, and are angled outwardly from the inlet end. In a second implementation, electrodes having tapered cross sections are positioned in mutually parallel relation.

RF multipoles constructed in accordance with embodiments of the present invention may be particularly useful for implementation in a collision/reaction cell, wherein the electrodes are disposed within an enclosure to which collision/reaction gas is added. By increasing r₀ from the inlet end to the outlet end of the RF multipole, the value of the Mathieu parameter q of an ion is progressively reduced in the direction of ion travel, resulting in a reduced effective low-mass cutoff and the availability of greater numbers of low-m/z ions for mass analysis. In addition, the RF multipoles may have decreased sensitivity to manufacturing or assembly errors and may promote higher ion transmission rates.

### BRIEF DESCRIPTION OF THE DRAWINGS

In the accompanying drawings:

FIG. 1 is a symbolic depiction of a mass spectrometer having a collision cell that incorporates an RF multipole constructed in accordance with a first embodiment of the invention, wherein the electrodes are angled outwardly to provide a monotonically increasing r₀;

FIG. 2 is an elevated side view of the RF multipole depicted in FIG. 1;

FIG. 3 is an end view of the RF multipole, depicting the inlet end;

FIG. 4 is an end view of the RF multipole, depicting the outlet end;

FIG. 5A is a product ion spectrum acquired by a triple quadrupole mass spectrometer having a collision cell of conventional design;

FIG. 5B is a corresponding product ion spectrum acquired by a triple quadrupole mass spectrometer having a collision cell constructed in accordance with an embodiment of the invention;

FIG. 6 is an elevated side view of a second embodiment of the RF multipole, wherein the electrodes are tapered to provide a monotonically increasing r₀; and

FIG. 7 is an inlet end view of the second embodiment of the RF multipole.

### DETAILED DESCRIPTION OF EMBODIMENTS

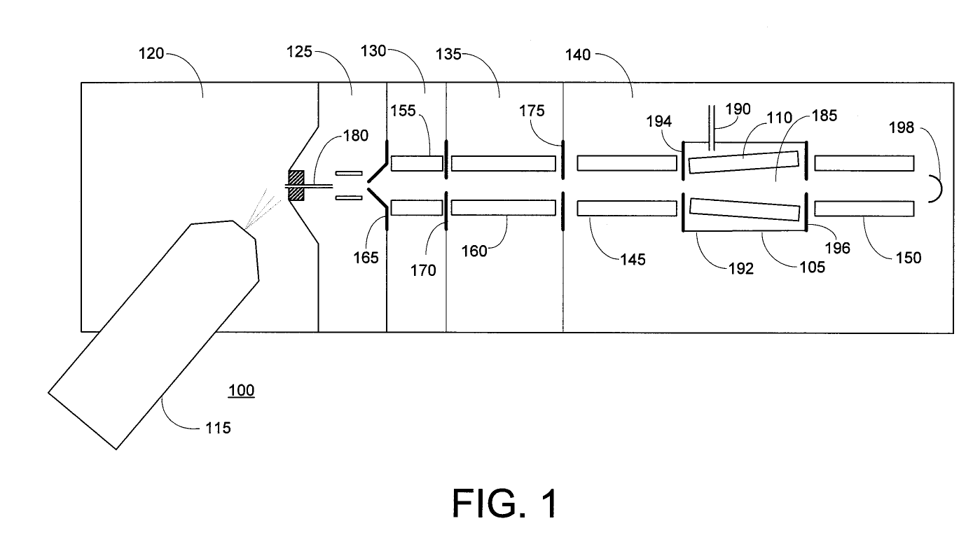

FIG. 1 depicts a triple quadrupole mass spectrometer 100 that incorporates a collision/reaction cell 105 having an RF multipole 110 constructed according to a first embodiment of the invention. It will be understood that certain features and configurations of mass spectrometer 100 are presented by way of illustrative examples, and should not be construed as limiting the invention to implementation in a specific environment. An ion source, which may take the form of an electrospray ion source 115, generates ions from an analyte material, for example the eluate from a liquid chromatograph (not depicted). The ions are transported from an ion source chamber 120, which for an electrospray source will typically be held at or near atmospheric pressure, through several intermediate chambers 125, 130 and 135 of successively lower pressure, to a vacuum chamber 140 in which resides a triple quadrupole mass analyzer having a first quadrupole mass filter (QMF) 145, collision/reaction cell 105, and a second QMF 150. Efficient transport of ions from ion source 115 to vacuum chamber 140 is facilitated by a number of ion optic components, including quadrupole RF ion guides 155 and 160, a skimmer 165, and electrostatic lenses 170 and 175. Ions may be transported between ion source chamber 120 and first intermediate chamber 125 through an ion transfer tube 180 that is heated to evaporate residual solvent and break up solvent-analyte clusters. Intermediate chambers 125, 130 and 135 and vacuum chamber 140 are evacuated by a suitable arrangement of pumps to maintain the pressures therein at the desired values. In one example, intermediate chamber 125 communicates with a port of a mechanical pump (not depicted), and intermediate pressure chambers 130 and 135 and vacuum chamber 140 communicate with corresponding ports of a multistage, multiport turbomolecular pump (also not depicted).

First QMF 145 and second QMF 150 each consist of four elongated electrodes to which RF and resolving DC voltages are applied. As is known in the art, the m/z ranges of the transmitted ions are determined by the amplitudes of the RF and resolving DC voltages (respectively designated as U and V), and ions having a desired range of m/z values may be selected for transmission by appropriately adjusting the values of U and V. Each QMF may be “parked” by temporally fixing the values of U and V such that only a single ion species is transmitted, or may instead be “scanned” by progressively changing U and/or V such that the m/z of the transmitted ions varies in time.

Collision/reaction cell 105 includes a multipole 110, constructed in accordance with embodiments of the present invention, located within an interior region 185 to which a collision/reaction gas is controllably supplied via a suitable collision gas source, such as a conduit 190 that receives gas from a suitable supply arrangement. The interior region 185 is defined by enclosure 192, which may be partially formed by entrance and exit lenses 194 and 196, and which enables development of an elevated pressure relative to the pressure of the vacuum chamber 140 which collision/reaction cell 105 is located. When configured as a collision cell, collision/reaction cell 105 is filled with a collision gas conventionally consisting of one or a mixture of generally unreactive or inert gases, such as nitrogen or argon, and the collision gas pressure within collision/reaction cell 105 is typically in the range of 0.5-10 millitorr. In an alternative reaction cell configuration, collision/reaction cell is filled with gas and/or reagent ions selected to react with the sample ions.

In operation as a conventional triple quadrupole mass spectrometer, a subset of ions entering vacuum chamber 140 is selectively transmitted by first QMF 145. The transmitted ions (“precursor ions”) enter collision cell 105, and a portion of the ions undergo energetic collisions to produce fragments (“product ions”). The product ions and residual precursor ions are passed to second QMF 150, which transmits ions within a selected range determined by the amplitudes of the applied RF and resolving DC voltages. The ions transmitted by second QMF 150 strike detector 198, which generates a signal representative of the numbers of ions impinging thereon. The detector signal is received and processed by control and data system (not depicted), which may be implemented as any one or combination of application-specific circuitry, general purpose and/or specialized processors, and software logic.

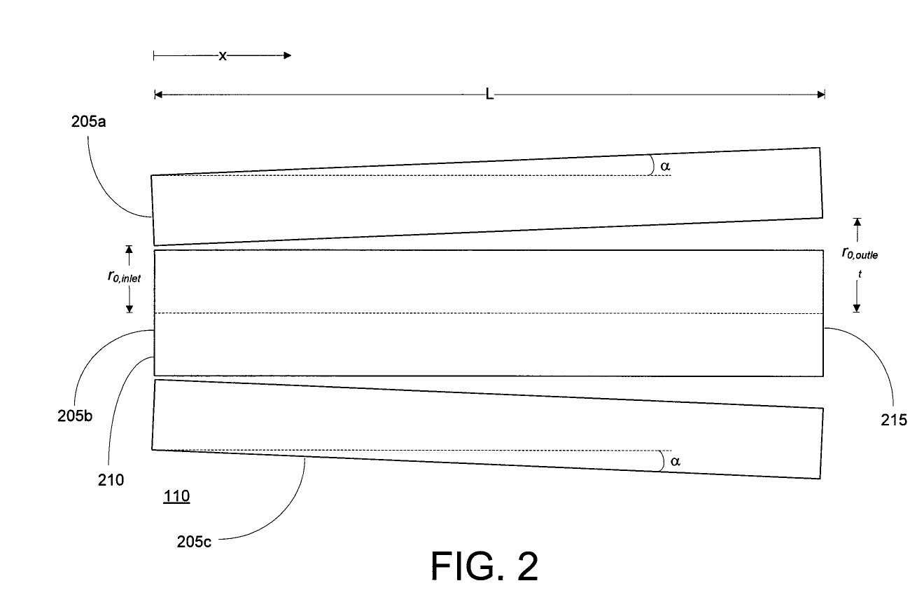

The arrangement of electrodes in multipole 110 may be more clearly explained with reference to FIGS. 2, 3 and 4, which respectively depict multipole 110 in elevated side view, inlet end view, and outlet end view. Multipole 110 includes four elongated electrodes 205a,b,c,d arranged at equal radial spacing from the axial centerline at each point along the multipole length. Each electrode 205a,b,c,d has a rectangular cross-section of longitudinally invariant dimensions. The central axes of electrodes 205a,b,c,d are angled outwardly in the direction of ion flow (by a splay angle α defined by the intersection of the electrode major axis with the central longitudinal axis or an axis parallel thereto) so that the value of the inscribed circle radius r₀ (the radius of the circle lying in a radial plane of the multipole that is tangent to the electrode inner surfaces) increases in a monotonic fashion from multipole inlet end 210 to multipole outlet end 215. In the example shown, the value of r₀ increases linearly from inlet end 210 to outlet end 215 according to the equation:

r₀=r_{0,inlet}+x/L*(r_{0,outlet}−r_{0,inlet})

where x is the distance from inlet end 210, L is the multipole length, and r_{0,inlet} and r_{0,outlet} are the values of the inscribed circle radius at inlet end 210 and outlet end 215, respectively. The electrodes may be precisely fixed in the desired geometry and spacing using ceramic holders or suitable equivalent, in a manner known in the art.

In alternative embodiments of the invention (such as the one discussed below), the variation of r₀ with distance along the multipole may follow a non-linear relation, such as a polynomial or logarithmic function. In order to avoid creating undesirable trapping regions, the increase of r₀ with distance along the multipole should be monotonic. It is further noted that although electrodes having rectangular cross-sections are depicted in FIGS. 2-4, the invention should not be construed as being limited to any particular electrode shape, and electrodes having other cross-sectional shapes (e.g., circular, hyperbolic) may be substituted. It is still further noted that the electrodes may be axially segmented into two or more sections in order to, for example, enable development of a DC axial field by applying different DC potentials to the electrode sections. It is further noted that in alternative embodiments of the invention, the electrodes may be spaced at different distances from the axial centerline at any given point along the multipole length, provided that the radial spacing for each electrode increases from the inlet end to the outlet end of the multipole.

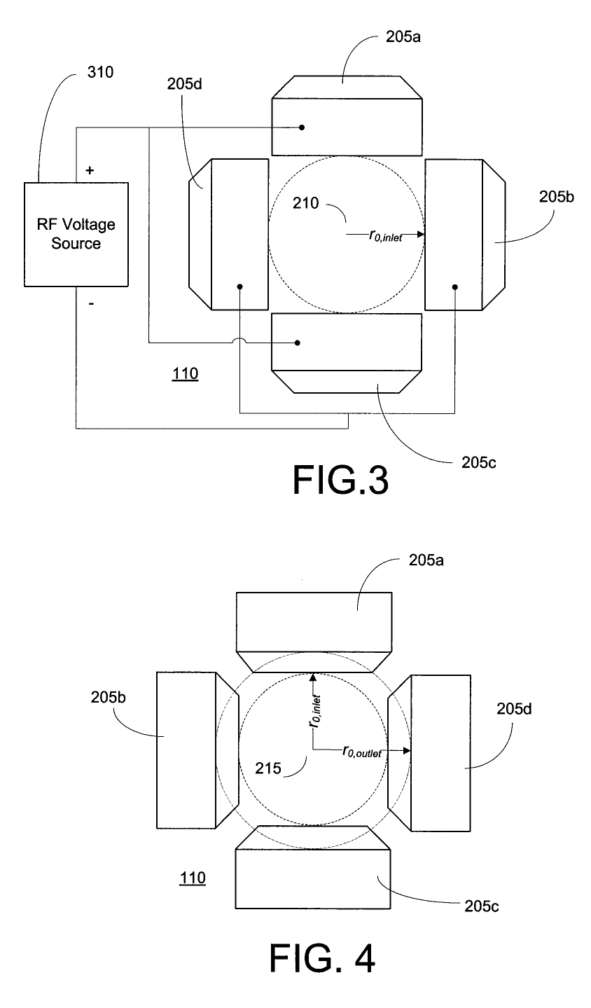

As known in the art and described above, an RF field that radially confines ions within multipole 110 is established by applying RF voltages in a prescribed phase relationship to electrodes 205a,b,c,d. FIG. 3 depicts an RF voltage source 310 that applies a first RF voltage to opposed electrodes 205a,c and a second RF voltage, having an amplitude and frequency equal to and a phase opposite to that of the first RF voltage, to opposed electrodes 205b,d. The Mathieu stability parameter q, which governs whether the trajectory of an ion within multipole 190 will be stable and hence whether the ion will reach outlet end 215, is proportional to the RF voltage amplitude and inversely proportional to the m/z of the ion and the square of the electrode radial spacing (r₀²). By angling electrodes 205a,b,c,d outwardly, the value of q for an ion of a given m/z located at outlet end 215 is reduced by a factor of (r_{0,inlet}/r_{0,outlet})² relative to the value of q that the ion would have at the outlet end of a conventional multipole having a fixed radial spacing of r_{0,inlet}. This decrease in q (which can alternatively be expressed as a decrease in the m/z of ions having a given q) with distance along the multipole allows the RF amplitude to be selected to provide good confinement of the relatively high m/z precursor ions entering multipole 105 while retaining a substantial portion of the relatively low m/z product ions formed by dissociation of the precursor ions in the downstream regions of the multipole.

Selection of an appropriate splay angle at which to arrange the electrodes will depend on the desired reduction in q and various operational and design considerations, primarily determined by the range product to precursor mass difference and the expected manufacturing tolerances. Typically, a splay angle and electrode length will be selected to yield a ratio of r₀ at the outlet end to r₀ at the inlet end that is at least 1.1, and more preferably at least 1.2. According to one illustrative implementation, each electrode 205a,b,c,d has a square cross section of 0.157 in.×0.157 in. (4 mm×4 mm) and a length of 8 in. (203.2 mm). Electrodes 205a,b,c,d are arranged at a radial spacing of 0.081 in. (2.06 mm) at inlet end 210 and are angled outwardly at a splay angle of about 0.19° so that the radial spacing at outlet end 215 is increased to 0.107 in. (2.72 mm). In this implementation, the q for an ion of a given m/z at outlet end 215 is (0.081/0.107)²=57% of its q at inlet end 210.

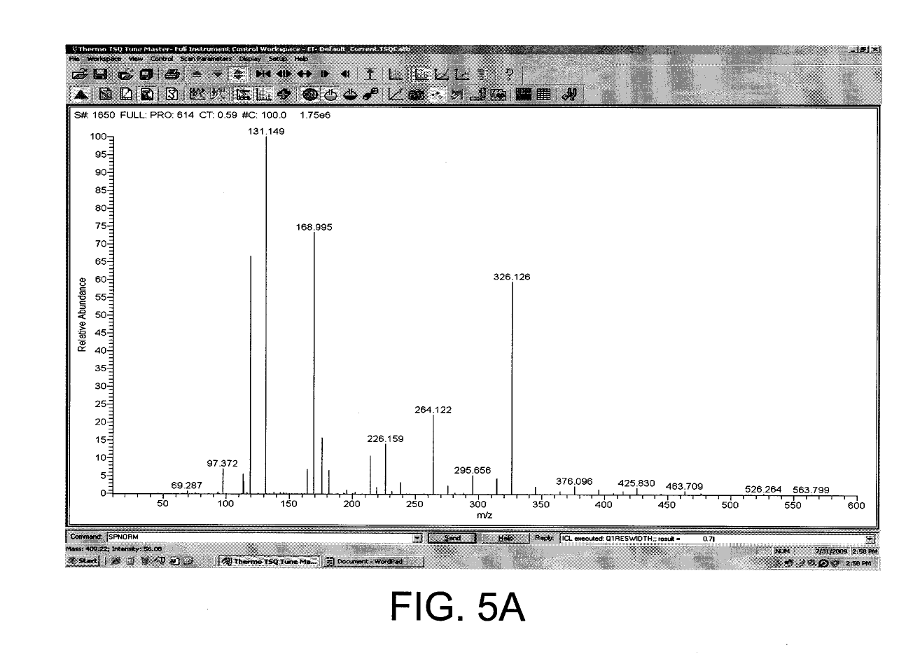

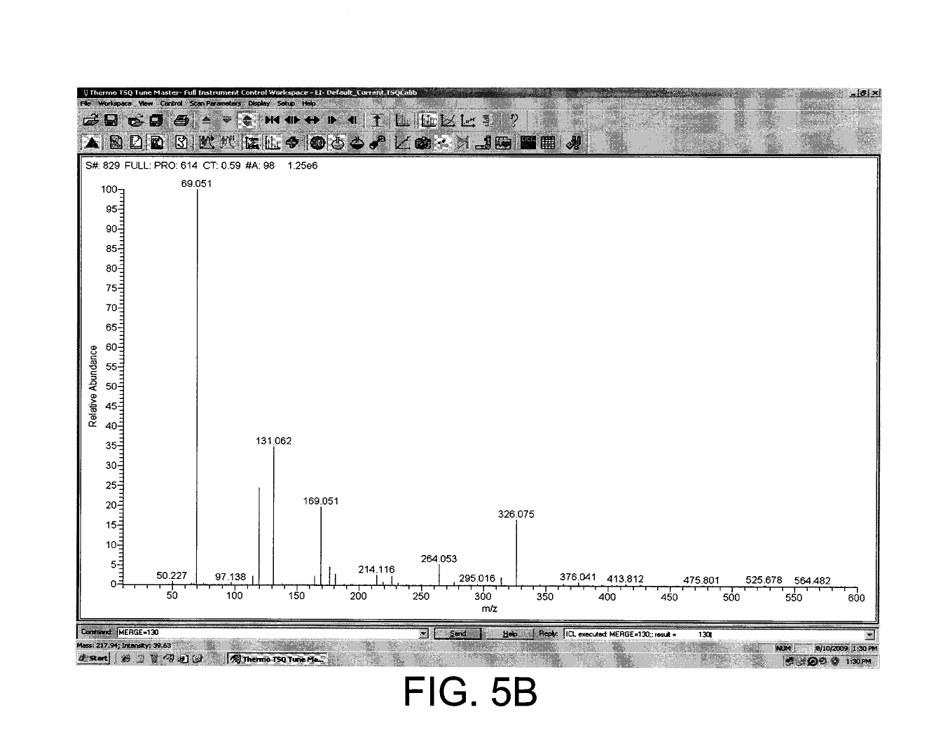

FIGS. 5A and 5B illustrate the effect of outwardly angling the electrodes of a collision cell quadrupole on transmission of low-mass product ions. The spectra depicted in FIGS. 5A and 5B were acquired under substantially identical conditions in a triple quadrupole mass spectrometer operated in product ion monitoring mode at a precursor m/z of 614 (corresponding to perfluorotributylamine ions produced by electron impact ionization of a calibration gas mixture). FIG. 5A is the product ion spectrum obtained using a conventional (invariant r₀) collision cell, whereas FIG. 5B is the product ion spectrum obtained using a collision cell with splayed electrodes constructed according to an embodiment of the invention. It is easily discernible that certain low m/z fragment ion peaks that are present in the FIG. 5B spectrum (namely, the peaks that appear at nominal m/z's of 50 and 69) are not seen or have much lower intensity in the FIG. 5A spectrum, indicating that such product ions were transmitted at significantly greater efficiency in the splayed electrode collision cell relative to the conventional collision cell.

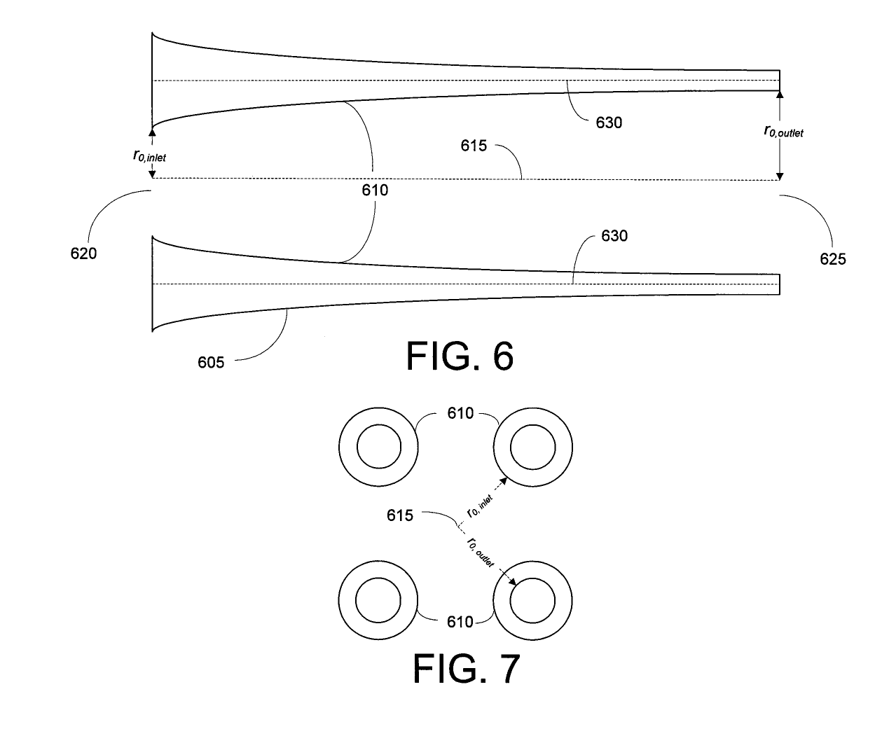

In addition to reducing q at and adjacent to outlet end 215 and lowering the low mass cutoff, increasing r₀ with distance along the multipole provides other benefits. As alluded to above, manufacturing errors or tolerances associated with the formation and positioning of electrodes in conventional multipoles having an invariant r₀ may create small convergent regions in which ions may be unintentionally trapped. Such convergent regions may also be created during operation of a mass spectrometer by deposition of contaminants on electrode surfaces. The unintended and undesirable creation of trapping regions in multipoles is avoided or minimized by outwardly angling the electrodes or otherwise increasing the electrode radial spacing with distance along the multipole (such as by tapering the electrodes, discussed below in connection with FIGS. 6 and 7), such that any narrowing of the radial spacing arising from manufacturing errors or contaminant deposition is compensated for by the increase in radial spacing with length inherent to multipoles constructed according to embodiments of the present invention.

It is has been further noted by the applicant that increasing r₀ in the direction of ion travel produces a pseudo-potential gradient that urges ions towards outlet end 215 of multipole 110. This effect may increase the rate at which ions are transported through multipole 110 and prevent stalling and unintended trapping of ions, particularly when collision cell 105 is operated at a relatively high pressure. Furthermore, the creation of a motive force arising from the pseudo-potential gradient may avoid the need (and associated cost and complexity) to provide structures for establishing an axial DC field.

Multipoles constructed in accordance with the present invention, i.e., having axially increasing r₀, may be utilized in other environments and for other purposes than collision/reaction cells. For example, multipoles of this general description may be employed as RF ion guides to transportions through regions of a mass spectrometer. In this implementation, ion transport efficiency may be advantageously increased by establishment of a pseudo-potential gradient that moves ions toward the outlet, as discussed above.

FIGS. 6 and 7 respectively depict elevated side and outlet end views of a multipole 605 constructed according to a second embodiment of the invention. Multipole 605 includes four elongated electrodes 610 (two of which are hidden from view in FIG. 6) arranged at equal radial spacing about an axial centerline 615. Each electrode 610 extends from an inlet end 620 to an outlet end 625, and is arranged with its central axis 630 parallel to axial centerline 615. To provide increasing r₀ in the direction of ion travel, each electrode 610 is tapered such that its cross-section decreases monotonically from inlet end 620 to outlet end 625, thereby monotonically increasing the distance between axial centerline 615 and the inner surface of electrode 610. To facilitate machining, each electrode 610 may have a circular lateral cross-section, although other cross-sectional shapes may be utilized and are within the scope of the invention. In FIGS. 6 and 7, electrodes 610 are formed to provide a non-linearly increasing r₀, but may in other implementations be formed to provide an r₀ that increases linearly with distance.

Although each of the multipoles described and depicted herein are quadrupoles (i.e., have exactly four electrodes), the concept of arranging or forming electrodes in an RF multipole to establish increasing r₀ may be extended to multipoles having a larger number of electrodes (e.g., hexapoles or octopoles). Furthermore, while the multipoles described and depicted herein have substantially straight axially centerlines, other embodiments may have a curved axial centerline, such as collision/reaction cells or ions guides that describe a 90-degree bend or are U-shaped.

In certain implementations of the invention, the multipole electrodes may be specially adapted (e.g., with a resistive coating) to enable application of a DC potential difference to ends of the electrodes in order to create a DC axial field. A desired DC axial field may also be established using a set of supplemental electrodes arranged adjacent to or around the main electrodes, as known in the prior art.

It should also be appreciated that RF multipoles constructed according to the present invention, i.e., with increasing r₀ from the inlet end to the outlet end, may be employed for purposes and in environments other than in a collision cell. For example, an RF multipole of this general description may be employed to efficiently transportions within an intermediate pressure region of the mass spectrometer located between the ion source and the mass analyzer(s). Other beneficial uses may occur to those of ordinary skill in the art.

Finally, it is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A collision/reaction cell for a mass spectrometer, comprising:
a radio frequency (RF) multipole having at least four elongated electrodes arranged around an axial centerline and extending from an inlet end to an outlet end, the radial spacing r₀ between the centerline and each of the electrodes increasing from the inlet end to the outlet end, and an RF voltage source for applying RF voltages to the electrodes to establish a radially confining field;
an enclosure arranged about the multipole; and
a collision/reaction gas source for adding collision/reaction gas to the interior of the enclosure.

2. The collision/reaction cell of claim 1, wherein r₀ increases monotonically from the inlet end to the outlet end.

3. The collision/reaction cell of claim 2, wherein r₀ increases linearly from the inlet end to the outlet end.

4. The collision/reaction cell of claim 2, wherein r₀ increases non-linearly from the inlet end to the outlet end.

5. The collision/reaction cell of claim 1, wherein the ratio of r₀ at the outlet end to r₀ at the inlet end is at least 1.1.

6. The collision/reaction cell of claim 1, wherein each of the electrodes is angled outwardly from the inlet end to the outlet end.

7. The collision/reaction cell of claim 1, wherein each of the electrodes is tapered from the inlet end to the outlet end.

8. The collision/reaction cell of claim 1, wherein the at least four electrodes consist of exactly four electrodes.

9. The collision/reaction cell of claim 1, wherein each of the electrodes has a circular lateral cross section.

10. The collision/reaction cell of claim 1, wherein each of the electrodes has a rectangular lateral cross section.

11. A tandem mass spectrometer, comprising:
an ion source;
first and second quadrupole mass filters;
a detector for generating a signal representative of the number of ions transmitted through the second quadrupole mass filter; and
a collision cell positioned in the ion path between the first and second quadrupole mass filters, the collision cell including:
at least four elongated electrodes arranged around an axial centerline and extending from an inlet end to an outlet end, the radial spacing r₀ between the centerline and each of the electrodes increasing from the inlet end to the outlet end;
an RF voltage source for applying RF voltages to the electrodes to establish a radially confining field;
an enclosure arranged about the electrodes;
and a collision gas source for adding collision gas to the interior of the enclosure.

12. The mass spectrometer of claim 11, wherein r₀ increases monotonically from the inlet end to the outlet end.

13. The mass spectrometer of claim 12, wherein r₀ increases linearly from the inlet end to the outlet end.

14. The mass spectrometer of claim 12, wherein r₀ increases non-linearly from the inlet end to the outlet end.

15. The mass spectrometer of claim 11, wherein the ratio of r₀ at the outlet end to r₀ at the inlet end is at least 1.1.

16. The mass spectrometer of claim 11, wherein each of the electrodes is angled outwardly from the inlet end to the outlet end.

17. The mass spectrometer of claim 11, wherein each of the electrodes is tapered from the inlet end to the outlet end.

18. The mass spectrometer of claim 11, wherein the collision gas source is controlled during operation to maintain a pressure of between 1 and 10 millitorr within the interior of the enclosure.

19. The mass spectrometer of claim 11, wherein the at least four electrodes consist of exactly four electrodes.

20. The mass spectrometer of claim 11, wherein each of the electrodes has a circular lateral cross section.

21. The mass spectrometer of claim 11, wherein each of the electrodes has a rectangular lateral cross section.

22. An RF multipole for transporting ions in a mass spectrometer, comprising:
at least four elongated electrodes arranged around an axial centerline and extending from an inlet end to an outlet end, the radial spacing r₀ between the centerline and each of the electrodes increasing from the inlet end to the outlet end; and
an RF voltage source for applying RF voltages to the electrodes to establish a radially confining field.
